(19) United States
(12) Patent Application Publication
(10) Pub. No.: US 2023/0055452 A1
(43) Pub. Date: Feb. 23, 2023

(54) BLISK MACHINING CENTER

(71) Applicant: KEDE NUMERICAL CONTROL CO., LTD., Dalian, Liaoning (CN)

(72) Inventors: Hu CHEN, Dalian, Liaoning (CN); Pei LIU, Dalian, Liaoning (CN); Lianyang WANG, Dalian, Liaoning (CN); Hongwei SUN, Dalian, Liaoning (CN); Zhihong WEI, Dalian, Liaoning (CN); Shaozhi LI, Dalian, Liaoning (CN); Hongtao TANG, Dalian, Liaoning (CN); Meng LIN, Dalian, Liaoning (CN); Mingshan SONG, Dalian, Liaoning (CN); Hongzhen GUO, Dalian, Liaoning (CN); Lujun GAO, Dalian, Liaoning (CN)

(21) Appl. No.: 17/794,866

(22) PCT Filed: Sep. 22, 2020
(86) PCT No.: PCT/CN2020/116911

§ 371 Date: Jul. 22, 2022

(30) Foreign Application Priority Data
Jan. 22, 2020 (CN) 202010075212.1

(51) Int. Cl. B23Q 3/18

(52) U.S. Cl. CPC B23Q 3/183; F01D 5/14

(57) ABSTRACT

The present invention provides a blisk machining center, including: A-axis rotary assembly, B-axis rotary assembly and C-axis rotary assembly, wherein the A-axis rotary assembly drives the blisk to rotate, the B-axis rotary assembly drives an attachment head to rotate, and the attachment head drives a tool to machine the blisk, and the C-axis rotary assembly drives the A-axis rotary assembly to rotate, wherein the intersection of the rotation axis of the B-axis rotary assembly and the rotation axis of the C-axis rotary assembly is the center of the machining area of the blisk, and the tip point of the tool is on the rotation axis of the B-axis rotary assembly. In the present invention, the machining area is near the rotation center of the C-axis turntable, which ensures that the speed and acceleration of the movement of each physical axis are kept within a lower range than those of general machine tools when the machine tool is performing the machining of the 5-axis rotary tool center point.

### TECHNICAL FIELD

The present invention relates to the field of machine tool machining, in particular to a blisk machining center.

### BACKGROUND ART

The use of blisks in aero-engines is a development trend of aero-engine technology in the world. In order to expand the application of blisks in aero-engines, difficulties in manufacturing the blisks must first be solved. At present, our aero engines are less likely to use blisks, and the main reason why they are not widely available is that the technical difficulties of manufacturing the blisks are still not solved. The difficulties in manufacturing aero-engine blisks lie in the complex profile of the blade, high machining accuracy and surface quality requirements, extremely high blade machining consistency, blade machining deformation and the materials used. The surface of the blisk blade is mostly free-form, which puts additional extremely high requirements on the machining accuracy and surface roughness of the blade. It is easier to achieve such machining accuracy when the surface to be machined is plane or cylindrical, but it is more difficult to achieve such machining requirements on a free-form surface. The tool movement space is limited during machining, which makes it more difficult to achieve high machining accuracy for the blade. Therefore, the machining of aero-engine blisks is a problem all over the world. Existing machine tools have extremely high requirements on the motion speed and acceleration range of each physical axis when performing the machining with the 5-axis rotary tool.

### SUMMARY OF INVENTION

The present invention provides a blisk machining center to overcome the above technical difficulties.

The present invention provides a blisk machining center, including: A-axis rotary assembly, B-axis rotary assembly and C-axis rotary assembly, wherein
the A-axis rotary assembly drives a blisk to rotate,
the B-axis rotary assembly drives an attachment head to rotate, and the attachment head drives a tool to machine the blisk,
the C-axis rotary assembly drives the A-axis rotary assembly to rotate,
the intersection of a rotation axis of the B-axis rotary assembly and a rotation axis of the C-axis rotary assembly is the center of the machining area of the blisk, and a tip point of the tool is on the rotation axis of the B-axis rotary assembly.

Further, the A-axis rotary assembly is an A-axis turntable driving the blisk to rotate,
the B-axis rotary assembly includes an attachment head on which the tool is fixed and a B-axis turntable (5), and the B-axis turntable (5) drives the attachment head (6) to rotate,
the C-axis rotary assembly is a C-axis turntable,
the A-axis turntable and the C-axis turntable are is detachably connected,
the rotation axis of the C-axis turntable is perpendicular to the horizontal plane, and is perpendicular to the rotation axis of the blisk.

Further, the A-axis turntable is fixed to the top surface of the C-axis turntable, and a central axis of the A-axis turntable is the rotation axis of the blisk.

Further, a tool magazine is included for replacing the tool, and the tool magazine is on the same side as the attachment head.

In the present invention, the machining area is near the rotation center of the C-axis turntable, which ensures that the speed and acceleration of the movement of each physical axis are kept within a lower range than those of general machine tools when the machine tool is performing the machining of the 5-axis rotary tool center point (hereinafter referred to as RTCP), and the central axis of the attachment head and the central axis of a ram form an included angle of 45° to ensure that the large speed and acceleration of the linear axis are avoided when the attachment head rotates the RTCP action.

### BRIEF DESCRIPTION OF DRAWINGS

In order to illustrate the embodiments of the present invention or the technical solutions in the prior art more clearly, the following briefly introduces the accompanying drawings that need to be used in the description of the embodiments or the prior art. Obviously, the accompanying drawings in the following description are some embodiments of the present invention, and for a person skilled in the art, other drawings can also be obtained from these accompanying drawings without creative effort.

FIG. 1 is a schematic diagram of the overall structure of the blisk machining center according to the present invention;

FIG. 2 is another perspective view of the overall structure of the blisk machining center according to the present invention;

FIG. 3 is a top view of the blisk machining center according to the present invention;

FIG. 4 is a flow chart of the blisk machining method according to the present invention;

FIG. 5 shows the velocity profiles of the X-axis, Y-axis and Z-axis during the machining of the blade according to the present invention;

FIG. 6 shows the speed profile of X-axis, Y-axis and Z-axis during the machining of the blade according to the prior art.

### DESCRIPTION OF EMBODIMENTS

In order to make the purposes, technical solutions and advantages of the embodiments of the present invention clearer, the technical solutions in the embodiments of the present invention will be clearly and completely described below with reference to the accompanying drawings in the embodiments of the present invention. Obviously, the embodiments to be described are some, but not all, embodiments of the present invention. Based on the embodiments of the present invention, all other embodiments obtained by a person skilled in the art without creative efforts are within the protection scope of the present invention.

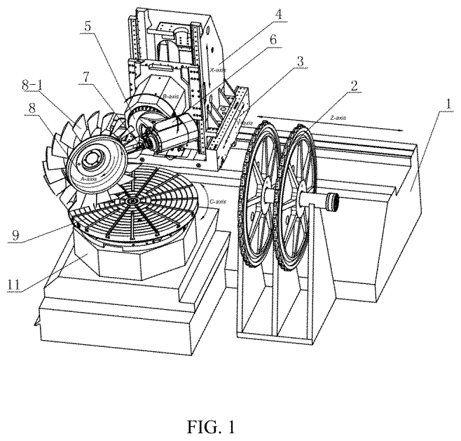

The present invention provides a blisk machining center, as shown in FIG. 1, which is a schematic diagram of the overall structure of the blisk machining center according to the present invention, including: a bed 1, a sliding table 3, column 4 and a ram, wherein the sliding table 3 and the bed 1 are slidably connected through guide rails, the column 4 and the sliding table 3 are slidably connected through guide rails, and one end of the ram and the column 4 are slidably connected through the guide rails, and further including: an A-axis rotary assembly, a B-axis rotary assembly and a C-axis rotary assembly, wherein
the A-axis rotary assembly drives blisk 8 to rotate,
the B-axis rotary assembly drives an attachment head 6 to rotate, and the attachment head 6 drives a tool 7 to machine the blisk 8,
the C-axis rotary assembly drives the A-axis rotary assembly to rotate, wherein
the intersection of a rotation axis of the B-axis rotary assembly and a rotation axis of the C-axis rotary assembly is the center of the machining area of the blisk 8, and a tip point of the tool 7 is on the rotation axis of the B-axis rotary assembly.

Further, the A-axis rotary assembly is an A-axis turntable 10 driving the blisk 8, and the B-axis rotary assembly includes an attachment head 6 on which the tool 7 is fixed and a B-axis turntable 5, the attachment head 6 being a 45° attachment head; one end of the 45° attachment head 6 and one end of the B-axis turntable 5 are rotatably connected, the tool 7 and the other end of the 45° attachment head 6 are fixedly connected, and the tool 7 is coaxial with the 45° attachment head 6; the included angle between the central axis of the tool 7 and the axis of the B-axis turntable 5 is 45°; the C-axis rotary assembly is a C-axis turntable 9 driving the A-axis turntable 10 to rotate; the A-axis turntable 10 and the C-axis turntable 9 are detachably connected, thus allowing to adjust the position of the A-axis turntable 10 before operation, and the drive output end of the A-axis turntable 10 and the blisk 8 are connected; the rotation axis of the C-axis turntable 9 is perpendicular to the horizontal plane, and is perpendicular to the rotation axis of the blisk 8, and the tool 7 machines the blisk 8; and the A-axis rotary assembly and the C-axis rotary assembly are located in front of the 45° attachment head 6.

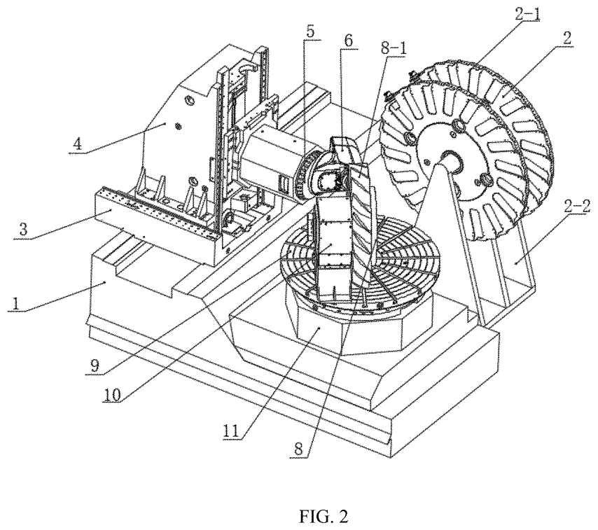

FIG. 2 is another perspective view of the overall structure of the blisk machining center according to the present invention, the blisk machining mechanism including: a B-axis turntable 5 driving the 45° attachment head 6 to rotate, an A-axis turntable 10 driving the blisk 8 to rotate, a C-axis turntable 9 driving the A-axis turntable 10 to rotate and a driving mechanism 11 driving the C-axis turntable 9 to rotate. The C-axis turntable 9 is circular, and the C-axis turntable 9 is parallel to the horizontal plane; the C-axis turntable 9 is fixed on the top surface of the A-axis turntable 10; the driving output end of the driving mechanism 11 and the C-axis turntable 9 are connected; the A-axis turntable 10 and the C-axis turntable 9 are detachably connected, the A-axis turntable 10 has a built-in driving motor, and the output end of the driving motor and the blisk 8 are rotatably connected; the driving mechanism 11 has a built-in driving motor, which drives the C-axis turntable 9 to rotate about C-axis, the C-axis turntable 9 drives the A-axis turntable 10 to rotate synchronously, and the A-axis turntable 10 drives the blisk 8 to rotate about the A-axis; the rotation axis of the C-axis turntable 9 is perpendicular to the horizontal plane and is perpendicular to the rotation axis of the blisk 8, and the tool 7 machines the side edge of the blisk 8.

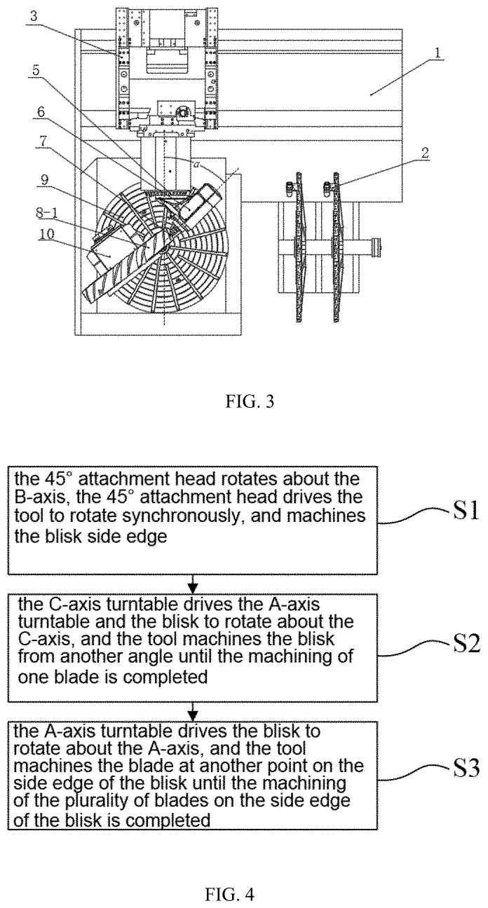

As shown in FIG. 3, the 45° attachment head 6 rotates about the B-axis; the intersection of a rotation axis of the B-axis rotary assembly and a rotation axis of the C-axis rotary assembly is the center of the machining area of the blisk 8, and a tip point of the tool 7 is on the rotation axis of the B-axis rotary assembly.

In the present invention, the machining area is near the rotation center of the C-axis turntable, which ensures that the speed and acceleration of the movement of each physical axis are kept within a lower range than those of general machine tools when the machine tool is performing an RTCP machining, and the included angle a between the central axis of the 45° attachment head 6 and the central axis of the B-axis turntable 5 is 45°, to ensure that the large speed and acceleration of the linear axis are avoided when the 45° attachment head rotates the RTCP action.

Further, in order to facilitate the replacement of the tool 7 that is worn out during long-term machining, a tool magazine 2 is further included for replacing the tool 7, and the tool magazine 2 is on the same side as the 45° attachment head 6, the tool magazine 2 including: a cutter head 2-1 and a tool holder 2-2, the cutter head 2-1 being rotatably connected to the tool holder 2-2, the rotation axis of the cutter head 2-1 being parallel to the horizontal plane; the tool 7 is snap connected to the side edge of the cutter head 2-1. The blisk 8 can be machined one by one, and the blades of the blisk 8 can be machined through replacing the tool in the tool magazine 2; the 45° attachment head 6 moves alternately along the Z axis, the Y axis and the X axis to the cutter head 2-1, and the cutter head 2-1 is driven by the motor to rotate (the drive motor of cutter head 2-1 is not illustrated) to make the hole position where the tool 7 is fixed to return to the initial position and the 45° attachment head 6 snaps the used tool into the hole position, and then the cutter head 2-1 rotates the tool 7 fixed thereon to the initial position, and the 45° attachment head 6 grabs the tool and starts to machine the next blisk.

Further, FIG. 4 shows a machining method based on the above-mentioned machining center, including the following steps:

S1: the 45° attachment head rotates about the B-axis, the 45° attachment head drives the tool to rotate synchronously, and machines the blisk side edge;

S2: the C-axis turntable 9 drives the A-axis turntable 10 and the blisk 8 to rotate about the C-axis, and the tool 7 machines the blisk 8 from another angle until the machining of one blade 8-1 is completed;

S3: the A-axis turntable 10 drives the blisk 8 to rotate about the A-axis, and the tool 7 machines the blade at another point on the side edge of the blisk 8 until the machining of the plurality of blades on the side edge of the blisk is completed.

S4: After the blade machining is completed, the 45° attachment head 6 drives the tool 7 to move to the tool magazine 2 along the Z axis to replace the tool 7.

The diameter of the blisk to be machined by the present invention is about 1 m, and the length of the blade is about 200 mm. The present invention uses the C-axis of the C-axis turntable 9 and the B-axis of the 45° attachment head 6 to perform 5-axis RTCP machining. The C-axis of the C-axis turntable 9 is a transfer axis and does not participate in the linked machining.

The present invention has the following advantages:

1. The relative position of the blisk 8 and the C-axis turntable 9 is set to ensure that the machining area is near the rotation center of the C-axis turntable 9, thus ensuring that the speed and acceleration of the movement of each physical shaft can be kept within a lower range than those of general machine tools when the machine tool is performing the machining of the 5-axis rotary tool center point.

2. The central axis of the 45° attachment head 6 and the central axis of the B-axis turntable 5 form an included angle of 45°, and the tip point of the tool 7 is on the central axis of the B-axis turntable 5, to ensure that the large speed and acceleration of the linear axis are avoided when the 45° attachment head performs the RTCP rotation.

3. The bulky spindle is prevented from moving along the X, Y and Z axes during machining.

Therefore, compared with the existing machine tool, the present invention can make the distance between the tool and the rotation center of the 45° attachment head as close as possible when using a longer tool, thereby reducing the speed and acceleration requirements of the RTCP action on the linear axis.

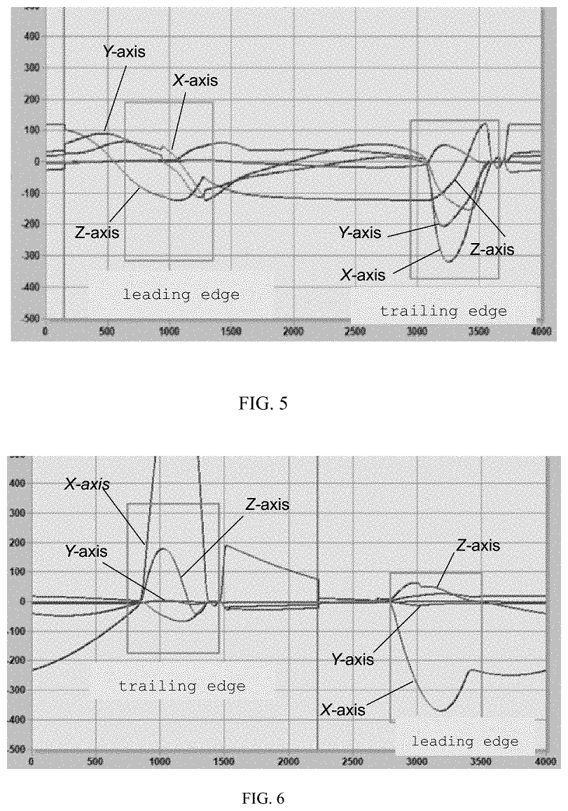

In summary, the present invention has obvious advantages in the blisk machining, especially in the machining of the leading edge and the trailing edge of the blade where the rotary axis movement is large. As a result of the simulation test, FIG. 5 shows the velocity profiles of the X-axis, Y-axis and Z-axis during the machining of the blade according to the present invention, and FIG. 6 shows the velocity profiles of the X-axis, Y-axis and Z-axis during the machining of the blade according to the prior art. After running the same machining program on the present invention and the existing machine tool, and then comparing the velocity profiles of X-axis, Y-axis and Z-axis in FIG. 5 and FIG. 6, it can be seen that the speed and acceleration of each physical shaft when machining the blade according to the present invention can be kept in a lower range than those of the existing machine tool.

Finally, it should be noted that: the above embodiments are only used to illustrate the technical solutions of the present invention, but not to limit them. Although the present invention has been described in detail with reference to the foregoing embodiments, a person skilled in the art should understand that: the technical solutions described in the foregoing embodiments can still be modified, or some or all of the technical features thereof can be equivalently substituted. However, these modifications or substitutions do not make the essence of the corresponding technical solutions deviate from the scope of the technical solutions of the embodiments of the present invention.

1. A blisk machining center, comprising: an A-axis rotary assembly, a B-axis rotary assembly and a C-axis rotary assembly, wherein
the A-axis rotary assembly drives the blisk (8) to rotate,
the B-axis rotary assembly drives an attachment head (6) to rotate, and the attachment head (6) drives a tool (7) to machine the blisk (8), and
the C-axis rotary assembly drives the A-axis rotary assembly to rotate,
wherein the intersection of a rotation axis of the B-axis rotary assembly and a rotation axis of the C-axis rotary assembly is the center of the machining area of the blisk (8), and a tip point of the tool (7) is on the rotation axis of the B-axis rotary assembly.

2. The machining center according to claim 1, wherein
the A-axis rotary assembly is an A-axis turntable (10) driving the blisk (8) to rotate,
the B-axis rotary assembly includes an attachment head (6) on which the tool (7) is fixed and a B-axis turntable (5), and the B-axis turntable (5) drives the attachment head (6) to rotate,
the C-axis rotary assembly is a C-axis turntable (9),
the A-axis turntable (10) and the C-axis turntable (9) are detachably connected,
the rotation axis of the C-axis turntable (9) is perpendicular to the horizontal plane, and is perpendicular to the rotation axis of the blisk (8).

3. The machining center according to claim 2, wherein
the A-axis turntable (10) is fixed to the top surface of the C-axis turntable (9), and a central axis of the A-axis turntable (10) is the rotation axis of the blisk (8).

4. The machining center according to claim 3, further comprising a tool magazine (2) for changing the tool (7), wherein the tool magazine (2) is on the same side as the attachment head (6).
